(19) United States
(12) Patent Application Publication
(10) Pub. No.: US 2014/0166257 A1
(43) Pub. Date: Jun. 19, 2014

(54) HEAT DISSIPATION COMPOSITE

(71) Applicant: DIODE-ON OPTOELECTRONICS LIMITED, Taichung City (TW)

(72) Inventors: Ivan Liu, Taichung City (TW); Shu-Ping Liu, Taipei (TW)

(73) Assignee: Diode-On Optoelectronics Limited, Taichung City (TW)

(21) Appl. No.: 13/719,996

(22) Filed: Dec. 19, 2012

(51) Int. Cl. F21V 29/00; F28F 21/08; F28F 21/04

(52) U.S. Cl. CPC F21V 29/004; F28F 21/04; F28F 21/081
USPC 165/185

(57) ABSTRACT

Disclosed herein is a heat dissipation composite having a metal substrate, a metal bonding layer, and a ceramic layer. The metal bonding layer has a melting point lower than that of the metal substrate and is formed on the metal substrate through metal-to-metal bonding. The ceramic layer is composed of ceramic powders and is covered on and bonded to the metal bonding layer opposite to the metal substrate.

### BACKGROUND OF THE INVENTION

1. Field of the Invention

This invention relates to a heat dissipation composite, more particularly to a heat dissipation composite without polymer adhesive.

2. Description of the Related Art

Many electronic devices generate great amounts of heat when being used. The elevated temperature caused by heat generation compromises efficiency of the electronic devices. Taking an LED light bulb as an example, high temperature caused by heat generation during illumination compromises LED luminous efficacy and might even damage the LED light bulb. Therefore, heat dissipation materials are likely to be used in an LED light bulb so as to reduce temperature in the bulb.

A metal layer coated with a ceramic layer is used as a heat dissipating composite for a conventional LED light bulb. The ceramic layer is capable of absorbing and radiating heat generated by the LED light bulb. The temperature in the LED light bulb is decreased and the lighting efficiency of the LED light bulb is therefore increased.

However, the ceramic layer is usually connected to the metal layer through an adhesive. For example, a ceramic material for the ceramic layer is mixed with the adhesive to form a jelly or a liquid mixture. The mixture is then coated or sprayed onto the metal layer. Most adhesives, however, are made of polymer which has low thermal conductivity and which impairs thermal dissipation of the ceramic layer.

### SUMMARY OF THE INVENTION

Therefore, an object of this invention is to provide a heat dissipation composite without polymer adhesive.

According to an aspect of this invention, there is provided a heat dissipation composite having a metal substrate, a metal bonding layer and a ceramic layer. The metal bonding layer has a melting point lower than that of the metal substrate and is formed on the metal substrate through metal-to-metal bonding. The ceramic layer is composed of ceramic powders and is covered on and bonded to the metal bonding layer opposite to the metal substrate.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary partly sectional view illustrating a preferred embodiment of a heat dissipation composite according to this invention;

FIG. 2 is a fragmentary sectional view illustrating a metal substrate and a metal bonding layer;

FIG. 3 is a fragmentary sectional view illustrating the metal bonding layer disposed on the metal substrate;

FIG. 4 is a fragmentary sectional view illustrating the metal bonding layer in a molten state;

FIG. 5 is a fragmentary sectional view illustrating ceramic powders sprayed onto the molten metal bonding layer; and

FIG. 6 is a partly sectional view showing the preferred embodiment of this invention applied to an LED light bulb.

### DETAILED DESCRIPTION OF THE PREFERRED EMBODIMENT

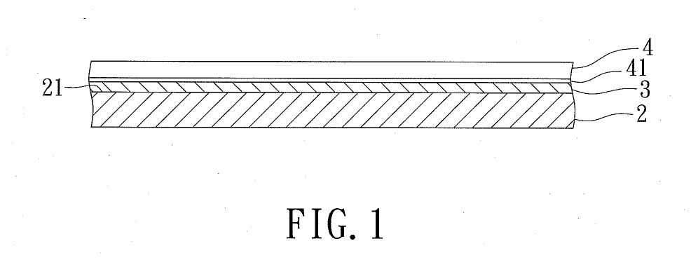

Referring to FIG. 1, the preferred embodiment of a heat dissipation composite according to this invention has a metal substrate 2, a metal bonding layer 3, and a ceramic layer 4.

The metal substrate 2 can be made of any suitable metal material according to its application field. In the preferred embodiment of this invention, the metal substrate 2 is used in LED light bulbs and therefore is preferably made of copper having a melting point of 1084° C.

The metal bonding layer 3 has a melting point lower than that of the metal substrate 2 and is formed on a surface 21 of the metal substrate 2 through metal-to-metal bonding. The metal bonding layer 3 preferably has low thermal resistance. In the preferred embodiment of this invention, the metal bonding layer 3 is made of tin which has a melting point of 232° C. The metal bonding layer 3 can be made of other metals as long as the melting point of the metal bonding layer 3 is lower than the melting point of the metal substrate 2.

The ceramic layer 4 is composed of ceramic powders and is covered on and bonded to the metal bonding layer 3 opposite to the metal substrate 2. The ceramic powders of the ceramic layer 4 are partially diffused into the metal bonding layer 3 so as to form an interbonding layer 41 between the metal bonding layer 3 and the ceramic layer 4, thereby tightly bonding the metal bonding layer 3 and the ceramic layer 4.

A preferred embodiment of a method of manufacturing the heat dissipation composite includes the following steps:

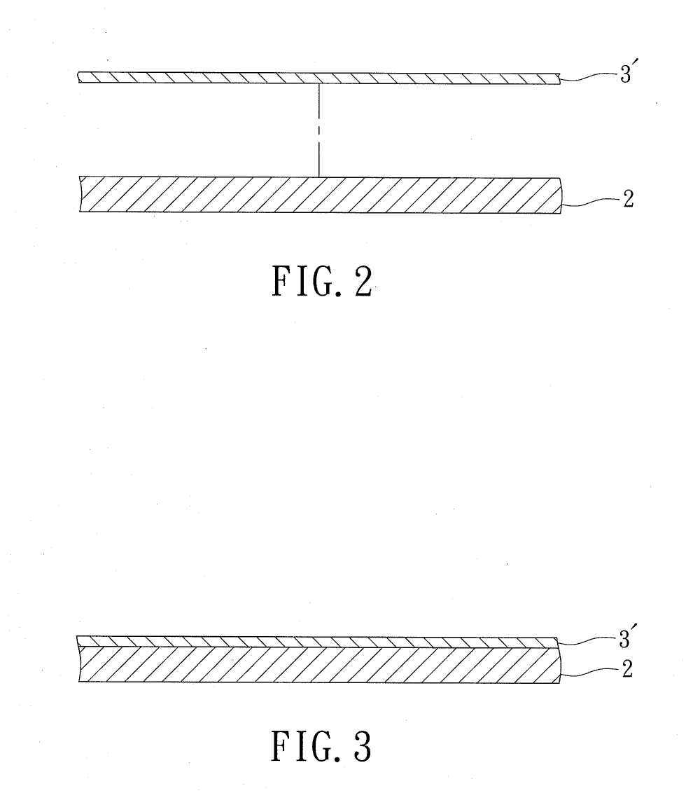

(a) disposing a metal 3′ on the metal substrate 2 (see FIGS. 2 and 3);

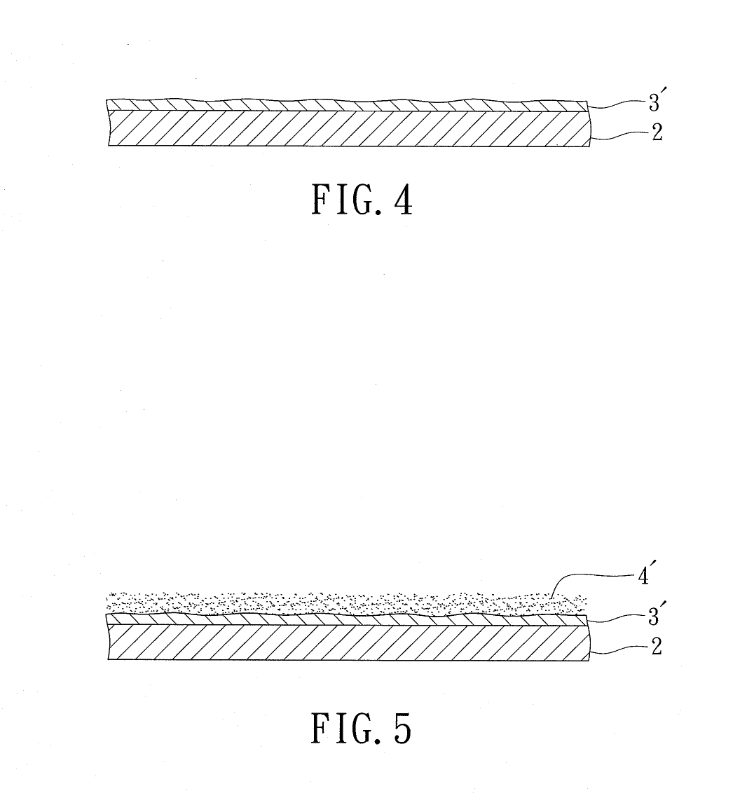

(b) heating the metal 3′ and the metal substrate 2 to a temperature higher than the melting point of the metal 3′ and lower than the melting point of the metal substrate 2 so as to allow the metal 3′ to be in a molten state while maintaining integrity of the metal substrate 2 (see FIG. 4); and

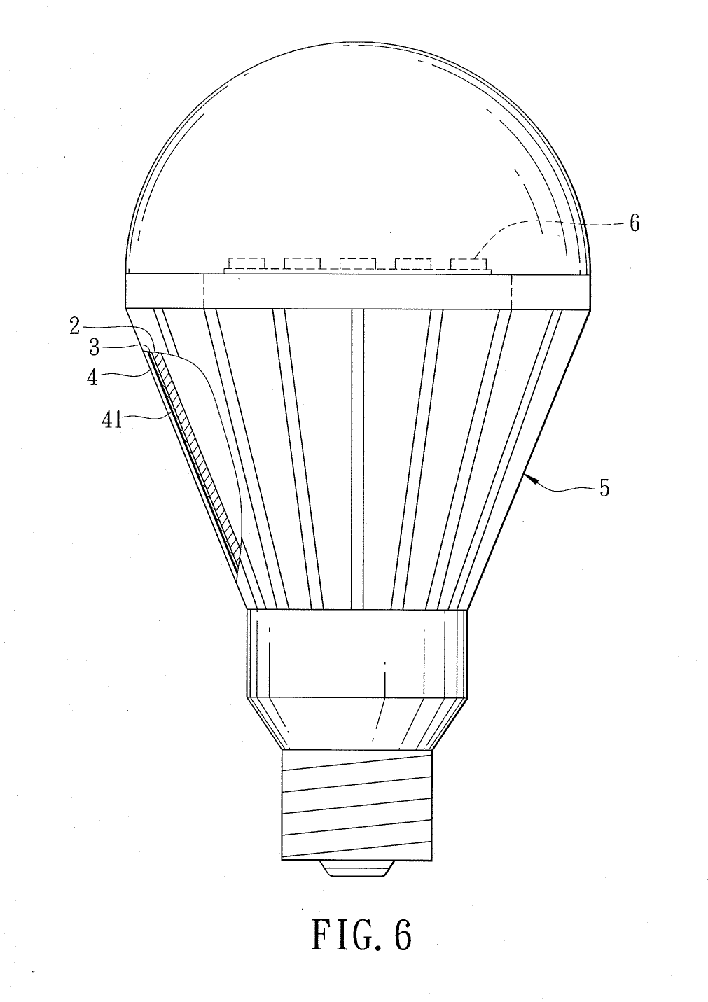

(c) after step (b), spraying the ceramic powders 4′ onto the molten metal 3′ to allow the ceramic powders 4′ to partially diffuse into the molten metal 3′ followed by cooling to form the heat dissipation composite (see FIGS. 1 and 5).

It is noted that, in Step (a), the metal 3′ can be disposed on the metal substrate 2 through techniques such as evaporation deposition, electroplating, sputtering, screen printing, spray coating, and so on depending on application of the heat dissipation composite.

It is also worth mentioning that the metal substrate 2, the metal bonding layer 3, and the ceramic layer 4 can be bonded together by diffusion welding which is done by heating at a temperature lower than the melting points of the metal substrate 2 and the metal bonding layer 3. Alternatively, in this invention, the metal 3′ can be replaced with a metal paste, for example, tin paste, followed by carrying out the heating and cooling steps as illustrated in Steps (b) and (c).

FIG. 6 illustrates use of the heat dissipation composite of this invention tomake an LED light bulb housing 5, in which the metal substrate 2 faces inwardly toward an array of LEDs 6 for absorbing and transmitting heat generated by the LEDs 6. The ceramic layer 4 of the heat dissipation composite faces outwardly and is capable of radiating the heat generated by the LEDs 6 toward the environment.

The heat dissipation composite can also be used in devices which require heat dissipation, for example, electronic circuit boards, power switches, memory chips, transistors, graphic cards, central processing units, and so on.

To sum up, with the metal bonding layer 3, which bonds to the metal substrate 2 by metal-to-metal bonding, and the interbonding layer 41 formed between the metal bonding layer 3 and the ceramic layer 4, the bonding strength between the metal substrate 2 and the ceramic layer 4 can be enhanced. Since metals have significantly higher thermal 5. conductivity than polymer adhesives, the heat dissipation composite having the metal bonding layer 3 thus has better heat dissipation capability.

While the present invention has been described in connection with what are considered the most practical embodiments, it is understood that this invention is not limited to the disclosed embodiments but is intended to cover various arrangements included within the spirit and scope of the broadest interpretation sous to encompass all such modifications and equivalent arrangements.

What is claimed is:

1. A heat dissipation composite, comprising:
a metal substrate;
a metal bonding layer having a melting point lower than that of said metal substrate and being formed on said metal substrate through metal-to-metal bonding; and
a ceramic layer that is composed of ceramic powders and that is covered on and bonded to said metal bonding layer opposite to said metal substrate.

2. The heat dissipation composite as claimed in claim 1, wherein said ceramic powders of said ceramic layer are partially diffused into said metal bonding layer so as to form an interbonding layer between said metal bonding layer and said ceramic layer.

3. The heat dissipation composite as claimed in claim 2, wherein said metal bonding layer is made of tin.
